(19) United States
(12) Patent Application Publication
(10) Pub. No.: US 2022/0251987 A1
(43) Pub. Date: Aug. 11, 2022

(54) EXHAUST GAS CATALYST SYSTEM

(71) Applicant: SAME DEUTZ-FAHR ITALIA S.P.A., Treviglio (Bergamo) (IT)

(72) Inventors: Manlio MATTEI, Treviglio (Bergamo) (IT); Luca CRIPPA, Treviglio (Bergamo) (IT)

(21) Appl. No.: 17/613,531

(22) PCT Filed: May 21, 2020
(86) PCT No.: PCT/IB2020/054834

§ 371 Date: Nov. 23, 2021

(30) Foreign Application Priority Data
Jun. 3, 2019 (IT) 102019000007863

(51) Int. Cl. F01N 3/035; B01D 53/94

(52) U.S. Cl. CPC F01N 3/035; B01D 53/9477

(57) ABSTRACT

An exhaust gas catalyst system for a vehicle, for treating fine dusts of exhaust gases produced by an internal combustion engine group of the vehicle, having an inlet duct and an outlet duct connectable to the internal combustion engine group and to a diesel particulate filter (DPF) system. A hollow main body extends along a main axis (X-X) between a head wall having an inlet opening and an outlet opening, and a bottom wall and defines a gas treatment chamber having a first chamber fluidically connected to the inlet opening and a second chamber fluidically connected to the outlet opening. The first and second chambers are fluidically connected in a region proximal to the bottom wall so exhaust gases flow in the first and second chambers in opposite directions. Exothermic filtration and oxidation operations are carried out on the fine dusts by a catalyst substrate housed in the second chamber.

The present invention relates to an exhaust gas catalyst for a vehicle. Furthermore, the present invention also relates to a vehicle comprising said exhaust gas catalyst system and to the method for treating the exhaust gases produced by an internal combustion engine group of a vehicle that uses said exhaust gas catalyst system.

In particular, in the following description, the term “vehicle” means a generic motor vehicle, while the term “tractor” means both agricultural tractors and, more generally, earthmoving machines that derive from agricultural tractors, or agricultural machines, for example harvesting machines.

In accordance with the present invention, the exhaust gas catalyst system may form part of a plant for treating exhaust gases with the aim of preventing the vehicle from producing pollutants and dispersing them into the environment. In particular, the exhaust gas treatment plants are fluidically connected to the internal combustion engine group, preferably a diesel-powered internal combustion engine group, and filter the fine dusts and/or reduce the nitrogen oxides (NOx) present in the exhaust gas produced by said internal combustion engine group.

Embodiments of these plants in which the exhaust gases are subjected to one or more operations for filtering and/or reducing the nitrogen oxides (NOx) emitted from the combustion chamber of the engine group are already known. In particular, the known plants comprise at least one filtration system that is suitable for removing the particles of fine dusts and at least one catalyst system that is suitable for reducing the nitrogen oxides NOx.

In accordance with the known embodiments, the particulate filtration systems have limited storage capacity and require frequent regeneration operations by means of the oxidation thereof. For example, solutions are known in which the filtration system, for example the DPF system, has to be cleaned intermittently or continuously to avoid extreme clogging that may damage the engine group and/or the filtering system itself.

In particular, the material trapped in the filtering system, that is the trapped fine dusts, largely consists of carbon particles together with a number of absorbed hydrocarbons. This unwanted material is removable by reacting it with oxygen (O2) or with nitrogen dioxide (NO2). In particular, in the prior art, the solutions that make use of nitrogen dioxide have become widespread, since the chemical reactions within them take place at controlled temperatures in most diesel exhausts.

In the above-mentioned context, solutions for plants for treating exhaust gases are likewise known, which implement a continuously regenerating system, for example the CRT® (Continuously Regenerating Trap) system, in which at least one oxidation catalyst group is provided upstream of the DPF system that is suitable for generating the NO2 necessary for keeping the filtration system clean. Up to a certain fine dust threshold value, the NO2-based oxidation reaction keeps the soot around its equilibrium point by oxidizing all the fine dusts produced by the engine group. If the equilibrium point of the particulate may not be reached, standstill/service regeneration is carried out.

As soon as the combustion operations of the engine group have finished, a small quantity of fuel is injected into the combustion chamber (delayed injection of the main injection system of the engine) such that hydrocarbons are created and burned in the catalyst substrate, causing an increase in the temperature of the exhaust gases that optimizes the operations inside the filtration system (i.e. in the DPF system).

Within the automotive sector (and also within the tractor and, in particular, the specialty tractor sector), in addition to the above framework, in particular the problem of managing the space in the vehicle has existed for some time. In particular, for some time there has been a need for the components and the systems of the vehicle to be as compact as possible and to have the smallest possible overall dimensions.

The plant for treating exhaust gases, and in particular the exhaust gas catalyst system thereof, is no exception to these problems and needs: solutions that are as compact as possible are well known in the art; in particular, solutions for exhaust gas catalyst systems that comprise fluidic paths that are suitably shaped to contain catalyst and/or filter groups in a desired position and to have the most compact dimensions possible are well known; in more detail, solutions for exhaust gas catalyst systems are known in which ducts and/or chambers are provided that are suitably shaped and fluidically connected so as to have the smallest possible overall dimensions, for example by being positioned one inside the other.

The object of the present invention is to provide an exhaust gas catalyst system solution that meets the above needs both in full and in an extremely efficient manner. In particular, the object of the present invention is to provide an exhaust gas catalyst system that has the most compact dimensions possible and at the same time allows for better management of the temperatures of the exhaust gases in order to make the operations of reducing the pollutant emissions as efficient as possible. This aim is achieved by an exhaust gas catalyst system as per claim 1. In addition, this aim is achieved by a vehicle comprising said exhaust gas catalyst system as per claim 6. Furthermore, this aim is achieved by a method for treating exhaust gases that is carried out by means of said exhaust gas catalyst system as per claim 8. The claims dependent on these claims describe additional preferred embodiments.

The features and the advantages of the system, of the vehicle and of the method of the present invention will become clear from the following description, given by way of non-limiting example, in accordance with the attached drawings, in which:

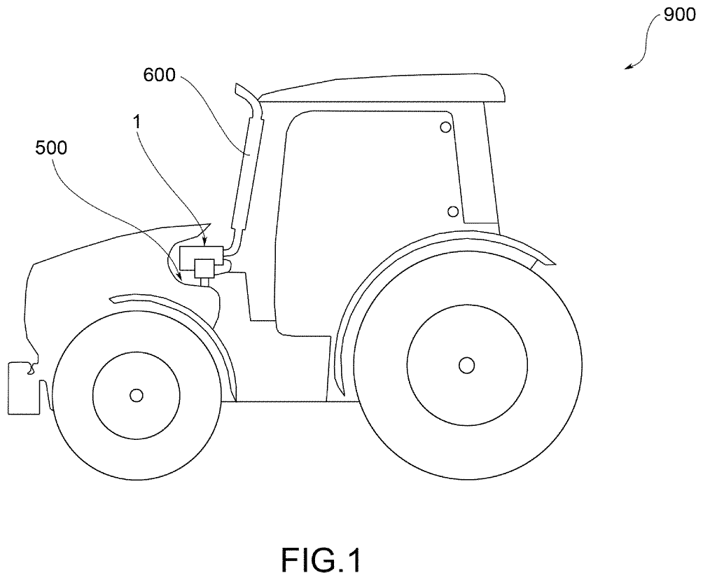

FIG. 1 is a schematic view of a vehicle, in particular of a tractor, as per the present invention according to a preferred embodiment;

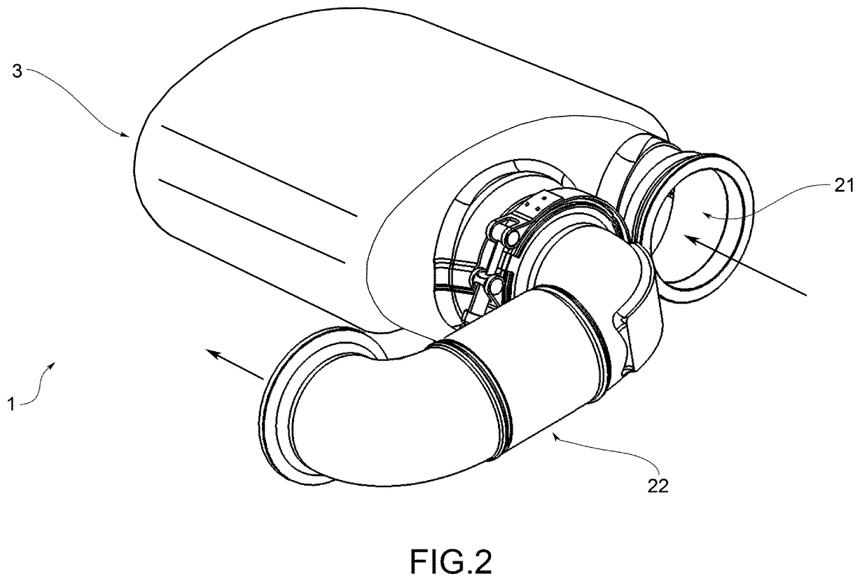

FIG. 2 is a perspective view, according to a preferred embodiment, of an exhaust gas catalyst system in accordance with the present invention;

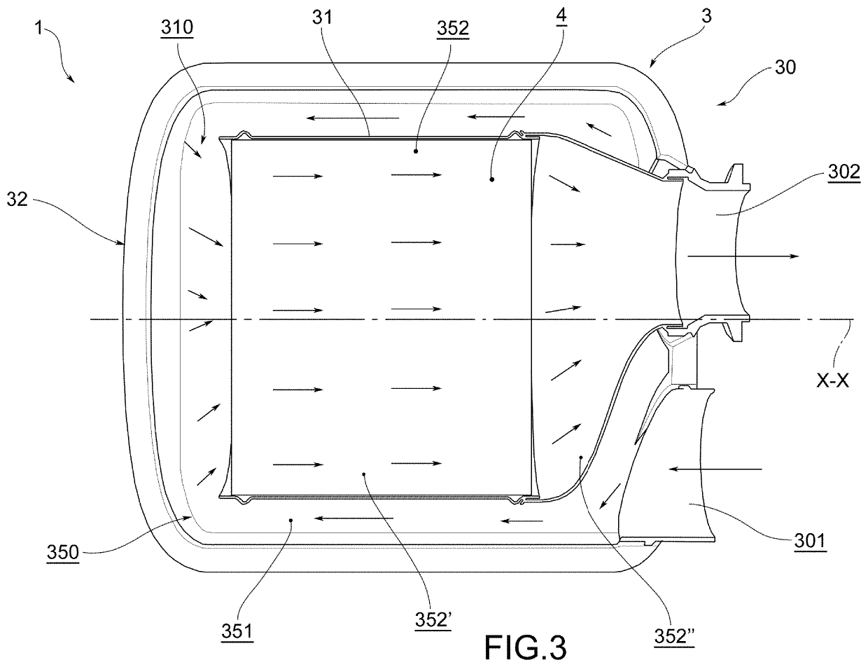

FIG. 3 is a longitudinal sectional view of the exhaust gas catalyst system shown in FIG. 2;

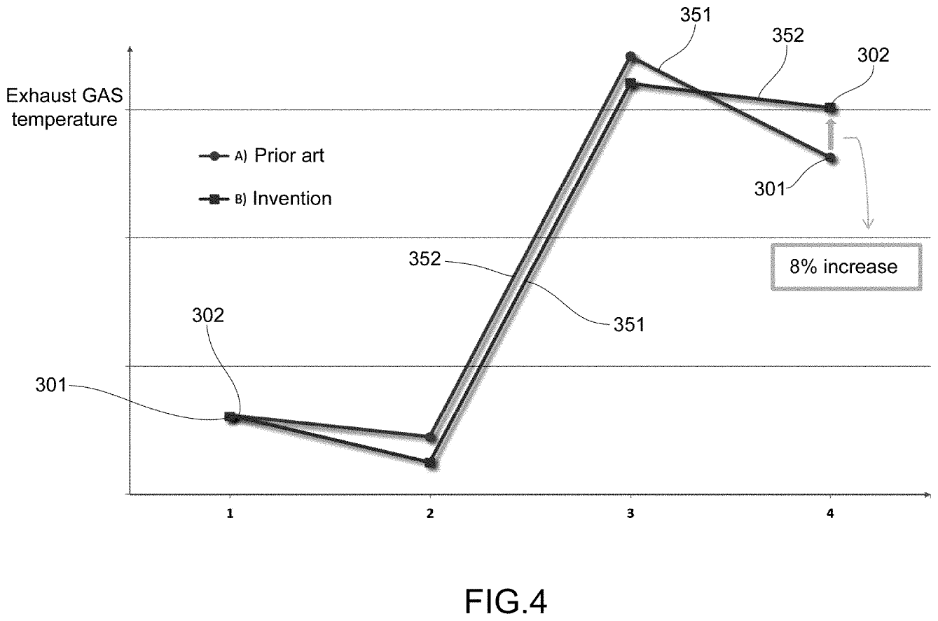

FIG. 4 is a graph showing the temperature of the exhaust gases inside the exhaust gas catalyst system of the present invention and inside an exhaust gas catalyst system as per a prior art embodiment.

In accordance with the attached drawings, 1 indicates, as a whole, an exhaust gas catalyst system according to the present invention. As described extensively in the following, the exhaust gas catalyst system 1 of the present invention is preferably a “DOC” (“Diesel Oxidation Catalyst”) system.

In addition, in accordance with the attached drawings, 900 indicates a vehicle according to the present invention (shown as a tractor in the drawings). Numeral 500 indicates an internal combustion engine group of said vehicle 900. The internal combustion engine group 500 is preferably a diesel-powered internal combustion engine group. The present invention is preferably not limited to specific embodiments of said internal combustion engine group 500.

Furthermore, numeral 600 indicates a DPF (acronym of “Diesel Particulate Filter”) system for “filtering” the fine dusts that is, in turn, comprised in the vehicle 900. In particular, a filtering system 600 means a system that is suitable for physical filtration or for performing a chemical reduction operation in order to prevent the dispersion of the fine dusts into the environment.

According to the present invention, the exhaust gas catalyst system 1 is suitable to carry out treatment operations, that is for filtering and/or reducing the nitrogen oxides in the exhaust gases produced by said internal combustion engine group 500. In particular, the exhaust gas catalyst system 1 is in fact fluidically connected to the internal combustion engine 500 upstream and to the environment (in particular to the “filtering” system 600) downstream.

As mentioned, the present invention also relates to a vehicle 900 comprising an internal combustion engine group 500, a filtering system 600 and an exhaust gas catalyst system 1 as per that described below. Preferably, the exhaust gas treatment system of the vehicle 1 is fluidically positioned in said vehicle 900 between the internal combustion engine group 500 and the filtering system 600.

Said vehicle is preferably a tractor or a specialty tractor.

In accordance with the present invention, the exhaust gas catalyst system 1 comprises an inlet duct 21 fluidically connectable to the internal combustion engine group 500 in order to receive the exhaust gases emitted.

Furthermore, in accordance with the present invention, the exhaust gas catalyst system 1 comprises an outlet duct 22 fluidically connectable to the environment in order to emit the exhaust gases post-treatment. The outlet duct 22 is therefore preferably fluidically connectable to the filtering system 600 arranged in the vehicle 900.

The shape of the inlet duct 21 and the outlet duct 22 and their arrangement in the vehicle are preferably not limiting for the purposes of the present invention.

According to the present invention, the exhaust gas catalyst system 1 comprises a main body 3 that is suitably fluidically connected such that the gas catalyzing operations are carried out inside said body.

The main body 3 extends lengthwise along a main axis X-X between a top wall 30 and a bottom wall 32 that are axially spaced apart.

According to the present invention, the top wall 30 comprises at least one inlet opening 301 that is fluidically connected to the inlet duct 21; via said inlet opening 301, the gases produced by the internal combustion engine group 500 therefore have access inside of the main body 3.

Furthermore, according to the present invention, the top wall 30 comprises at least one outlet opening 302 that is fluidically connected to the outlet duct 22; via said outlet opening 302, the gases are therefore evacuated towards the environment (towards the filtration system 600) following the treatment operations that take place in the main body 3.

In accordance with the present invention, the main body 3 is hollow and internally defines a gas treatment chamber 350.

In particular, said gas treatment chamber 350 comprises a first chamber and a second chamber, one radially extending distally with respect to said main axis X-X and the other extending along the main axis X-X, respectively.

The annular chamber 351 radially extends distally from the main axis X-X. The central chamber 352 instead extends on the main axis X-X. In other words, the two chambers are positioned one inside the other. In particular, the central chamber 352 is surrounded by the annular chamber 351 either fully or in part.

Said annular chamber 351 is fluidically connected to the inlet opening 301. The annular chamber 351 is therefore the first chamber inside the main body 3 inside which the exhaust gases arriving from the engine group 500 flow.

Said central chamber 352 is fluidically connected to the outlet opening 302. The central chamber 352 is therefore the second chamber inside the main body 3 inside which the exhaust gases flow after they have passed through the annular chamber 351 (or the first chamber).

In accordance with a preferred embodiment, the central chamber 352 and the annular chamber 351 are in fact separated from one another by a separation wall 31.

Said separation wall 31 preferably extends lengthwise in parallel with the axis X-X from the top wall 30 towards the bottom wall 32.

According to the present invention, the annular chamber 351 and the central chamber 352 are in fact fluidically connected in a region that is proximal to the bottom wall 32.

According to a preferred embodiment, the separation wall 31 comprises outflow openings 310 near the bottom wall 32, via which openings the gases flow from the annular chamber 351 to the central chamber 352.

According to a preferred variant, the separation wall 31 axially ends in a region that is proximal to the bottom wall 32, thereby defining an outflow opening 310 through which the gases flow from the annular chamber 351 to the central chamber 352.

In accordance with a preferred embodiment, the bottom wall 32 is shaped so as to facilitate the flow of the gases from the annular chamber 351 to the central chamber 352.

The bottom wall 32 is preferably curved or shaped so as to direct the gases from the annular chamber 351 to the central chamber 352.

Therefore, in accordance with the present invention, the first chamber and the second chamber are fluidically connected such that the exhaust gases flow in the two chambers in opposite directions along the main axis X-X. In the annular chamber 351, the exhaust gases flow from the top wall 30 towards the bottom wall 32, while, in the central chamber 352, the exhaust gases flow from the bottom wall 32 towards the top wall 30.

In accordance with the present invention, the exhaust gas catalyst system 1 also comprises a catalyst substrate 4. According to the present invention, when the exhaust gases pass through the catalyst substrate 4, said substrate carries out a filtration action and, especially, an oxidation action on the particulate.

In accordance with the present invention, the catalyst substrate 4 is housed in said second chamber 352 (that is in said central chamber). That is to say that the catalyst substrate 4 is the last component that the flow of exhaust gas passes through before reaching and passing through the outlet opening 302.

In accordance with the present invention, the operations on the exhaust gases that result in an increase in the temperature (of said gases) are therefore the last to be carried out before said gases leave the main body 3. Therefore, exhaust gases that are treated by the catalyst substrate 4 and have a “high temperature” preferably leave via the outlet opening 302.

According to a preferred embodiment, the central chamber 352 reaches higher temperatures than the annular chamber 351 surrounding it. In accordance with the present invention, the increase in the temperature in the central chamber 352 also causes the annular chamber 351 to heat up. The gases flowing out into the annular chamber 351 are therefore subjected to a pre-heating step.

In accordance with a preferred embodiment, the central chamber 352 comprises a catalyzing region 352′ that is axially proximal to the bottom wall 32 and a bottleneck 352″.

The bottleneck 352″ preferably prevents the gases from leaving, thereby prolonging the time it takes for said gases to pass through the catalyzing region 352′.

Said bottleneck 362″ is preferably arranged between the catalyzing region 352′ and the outlet opening 302.

In accordance with a preferred embodiment, the annular chamber 351 delimits a fluidic conduit for the flow of exhaust gases, in which the gases flow undisturbed but are subjected to the higher temperatures produced in the central chamber 352. The annular chamber is, to all intents and purposes, a “preheating” chamber.

The graph in FIG. 4 shows a comparison between the temperature of the exhaust gases through the exhaust gas catalyst system 1 of the present invention and the temperature of the exhaust gases through a solution for an exhaust gas catalyst system having the same shape and dimensions but having the opposite function to that of the present invention, that is in which the gases first pass through the central chamber (in which the catalyst is housed) and then the annular chamber, before leaving towards the environment.

The graph in FIG. 4 shows how the temperature of the exhaust gases leaving the exhaust gas catalyst system of the present invention is significantly higher than in the opposite case, by approximately 10%.

Therefore, the exhaust gases that reach the filtration system 600 after having fluidically passed through the exhaust gas catalyst system 1 of the present invention advantageously have a higher temperature, thereby allowing for an effective action by said filtration system 600.

As mentioned, the present invention also relates to a method for treating the exhaust gases produced by an internal combustion engine group 500 of a vehicle 900. This method comprises the step of fluidically connecting an exhaust gas catalyst system, such as that described above, to the internal combustion engine group 500 of the vehicle and to the filtration system 600 of the vehicle, and comprises the step of allowing exhaust gases produced by the internal combustion engine group 500 to flow into the first chamber 351 and then into the second central chamber 352 (in which the catalyst substrate 4 is housed) such that the catalyzing operations are carried out in the vicinity of the outlet opening 302.

Innovatively, the exhaust gas catalyst system, the vehicle comprising said exhaust gas catalyst system and the method for treating exhaust gases that is carried out by means of said exhaust gas catalyst system make it possible to achieve the object set by the invention, that is to meet the needs of the relevant technical sector, both in full and in an extremely efficient manner, by proposing an effective action of removing the fine dust particles.

Advantageously, the position of the catalyst substrate in a region that is proximal to the outlet opening of the exhaust gas catalyst system prevents the heat loss to which these gases are typically subjected. The DPF “filtration” system is advantageously achieved by high-temperature gas operating in ideal and highly efficient conditions.

Advantageously, the exhaust gas catalyst system of the present invention reduces the amount of heat dissipation that occurs during the exothermic catalytic oxidation reaction, thereby reducing the overall loss in temperature of the exhaust gases by means of the system itself and ensuring that the DPF filtration system is reached by a temperature of the exhaust gases sufficiently high to encourage full regeneration of the component over the course of its life.

Advantageously, the regeneration operations of these components and/or systems, that occur when the vehicle is stationary, are extremely effective and efficient, resulting in shorter vehicle downtime.

Advantageously, the exhaust gas catalyst system is extremely compact.

It is clear that, in order to meet contingent needs, an expert in the field could make modifications to the subject matter of the present invention described above, all of which are within the scope of protection defined by the following claims.

1. An exhaust gas catalyst system of a vehicle, comprising an internal combustion engine group and a diesel particulate filter (DPF) system, wherein said exhaust gas catalyst system is suitable for performing treatment operations of fine dusts of exhaust gases produced by said internal combustion engine group, said exhaust gas catalyst system comprising:
an inlet duct fluidly connectable to the internal combustion engine group to receive the exhaust gases;
an outlet duct fluidly connectable to the DPF system connected to the environment; and
a main body which extends in length along a main axis (X-X) between a head wall comprising at least one inlet opening fluidly connected to the inlet duct and at least one outlet opening fluidly connected to the outlet duct, and a bottom wall;
wherein the main body is hollow and internally defines a gas treatment chamber, said gas treatment chamber comprising a first chamber fluidly connected to the at least one inlet opening, and a second chamber, fluidly connected to the at least one outlet opening, said first and second chambers respectively having a radially distal development with respect to said main axis (X-X) and a development along the main axis (X-X), wherein the first chamber and the second chamber are separated from each other by a separation wall;
wherein the first chamber and the second chamber are fluidly connected in a region proximal to the bottom wall, such that flows of the exhaust gases in the first and second chambers are in counter-flow along the main axis (X-X); and
wherein the exhaust gas catalyst system further comprises a catalyst substrate through which exothermic filtration and oxidation operations are performed on the fine dusts present in the exhaust gases, said catalyst substrate being housed in said second chamber.

2. The exhaust gas catalyst system of claim 1, wherein the first chamber is an annular chamber having distal development with respect to said main axis (X-X) and the second chamber is a central chamber having development along the main axis (X-X), wherein said central chamber is entirely or at least partly surrounded by the annular chamber, and wherein the annular chamber and the central chamber are mutually separated by a separation wall which extends along the main axis (X-X) and are fluidly connected in a region proximal to the bottom wall, in such a way that the flows of the exhaust gases in the annular and central chambers are in counter-flow along the main axis (X-X), wherein in the passage between the annular chamber and the central chamber the flows of the exhaust gases are in a radial direction from outside to inside.

3. The exhaust gas catalyst system of claim 2, wherein the central chamber comprises a catalyzing region axially proximal to the bottom wall and a bottleneck positioned between the catalyzing region and the at least one outlet opening, wherein said bottleneck hinders outflow of the exhaust gases, prolonging crossing time in the catalyzing region.

4. The exhaust gas catalyst system of claim 2, wherein the annular chamber defines a fluidic conduit for flow of the exhaust gases in which the exhaust gases flow undisturbed and are subjected to heating operations due to higher temperatures produced in the central chamber.

5. The exhaust gas catalyst system of claim 1, wherein the bottom wall has a shape that facilitates the flow of the exhaust gases from the first chamber to the second chamber.

6. A vehicle comprising an internal combustion engine group, a diesel particulate filter (DPF) system, and an exhaust gas catalytic system according to claim 1, wherein said exhaust gas catalyst system is upstream fluidly connected to said internal combustion engine group and downstream fluidly connected to said DPF system.

7. The vehicle of claim 6, wherein said vehicle is a tractor or a specialty tractor.

8. A method for treating exhaust gases of a vehicle, wherein said exhaust gases are produced by an internal combustion engine group of the vehicle, and wherein said vehicle comprises a diesel particulate filter (DPF) system, said method comprising:
fluidly connecting an exhaust gas catalyst system suitable for performing treatment operations of fine dusts of the exhaust gases produced by said internal combustion engine group to the internal combustion engine group and to the DPF system, said exhaust gas catalyst system comprising:
an inlet duct fluidly connectable to the internal combustion engine group to receive the exhaust gases;
an outlet duct fluidly connectable to the DPF system connected to the environment; and
a main body which extends in length along a main axis (X-X) between a head wall comprising at least one inlet opening fluidly connected to the inlet duct and at least one outlet opening fluidly connected to the outlet duct, and a bottom wall;
wherein the main body is hollow and internally defines a gas treatment chamber, said gas treatment chamber comprising a first chamber fluidly connected to the at least one inlet opening, and a second chamber fluidly connected to the at least one outlet opening, said first and second chambers respectively having a radially distal development with respect to said main axis (X-X) and a development along the main axis (X-X), wherein the first chamber and the second chamber are separated from each other by a separation wall;
wherein the first chamber and the second chamber are fluidly connected in a region proximal to the bottom wall, such that flows of the exhaust gases in the first and second chambers are in counter-flow along the main axis (X-X); and
wherein the exhaust gas catalyst system further comprises a catalyst substrate through which exothermic filtration and oxidation operations are performed on the fine dusts present in the exhaust gases, said catalyst substrate being housed in said second chamber; and
allowing the exhaust gases produced by the internal combustion engine group to flow into the first chamber and then into the second chamber, so that catalyzing operations are carried out in proximity of the at least one outlet opening in direction of the DPF system.

9. The exhaust gas catalyst system of claim 2, wherein said bottom wall is curved or shaped to direct the exhaust gases from the annular chamber to the central chamber.
